(19) United States
(12) Patent Application Publication
(10) Pub. No.: US 2008/0089501 A1
(43) Pub. Date: Apr. 17, 2008

(54) Caller ID spoofing

(75) Inventors: David S. Benco, Winfield, IL (US); Paresh C. Kanabar, Naperville, IL (US); John C. V. Nguyen, Naperville, IL (US); Huixian Song, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/581,634

(22) Filed: Oct. 16, 2006

(51) Int. Cl. H04M 15/06

(52) U.S. Cl. 379/142.01

(57) ABSTRACT

A method of caller ID spoofing includes: receiving a call at a first telecommunications facility (30) from a calling party served by the first telecommunications facility (30), the call being intended for a called party; determining if a caller ID spoofing feature (33) has been invoked for the call; if the caller ID spoofing feature (33) has not been invoked for the call, then establishing true caller ID information for the calling party; and, if the caller ID spoofing feature (33) has been invoked for the call, then establishing false caller ID information for the calling party.

### FIELD

The present inventive subject matter relates to the telecommunication arts. Particular application is found in conjunction with certain types of telecommunication networks, and the specification makes particular reference thereto. However, it is to be appreciated that aspects of the present inventive subject matter are also amenable to other like applications and/or networks.

### BACKGROUND

In telecommunications networks, the caller ID function or service (also known in various instances as Calling Line Identification (CLI), Caller Display, Calling Line Identification Presentation (CLIP), Call capture, Calling Line Identity (CLID), Call Display, etc.) is generally well known. Typically, when a call is placed by a calling party to a called party, e.g., over a public switched telephone network (PSTN), if the called party subscribes to the caller ID feature or service, then the called party is typically provided with the telephone number or other identifying information for the calling party. For example, the telephone number or name of the calling party may be output on a display associated with the called party's telephone or other end user terminal when it rings or is otherwise alerted of the incoming call. Accordingly, the called party is given the opportunity to determine who is calling before they choose whether or not to answer the call.

Commonly, the calling party's exchange or the originating end office or other call origination switching facility or originating node serving the calling party captures or otherwise obtains the telephone number of the calling party, e.g., the directory number or line number of the calling party, and during the call setup provides the same to the called party's exchange or the terminating end office or other call termination switching facility or terminating node serving the called party. For example, when employing the Signaling System No. 7 (SS7) protocol for call setup, the calling party number is provided by the calling party's exchange to the called party's exchange in a Calling Party Number Message (CPNM). Typically, the called party's exchange translates the CPNM into a form suitable for providing the caller ID information to the called party. For example, using a technique known as Frequency Shift Keying (FSK), this information is sent to the called party between the first and second ring or other alerting signals. Generally, the caller ID information is provided to the called party in one of two formats, namely, Single Data Message Format (SDMF), which provides the calling party's telephone number, or Multiple Data Message Format (MDMF), which in addition to the information provided by the SDMF, also provides the directory listed name or subscriber name associated with the telephone number.

By providing an indication of the calling party's identity, caller ID generally allows the called party to selectively screen calls they do not wish to answer for whatever reason, e.g., calls from someone whom the called party wishes to avoid. Accordingly, a caller ID blocking feature has been developed in which a calling party may opt to block their telephone number or other identifying information from being revealed to the called party via the caller ID service. In general, caller ID blocking is a well known feature. For example, a calling party may elect to have their caller ID information blocked for all outgoing calls (i.e., complete caller ID blocking) or may chose to block it on a per call basis, e.g., by dialing a feature code prior to dialing the telephone number they are calling (i.e., selective caller ID blocking). In either case, when the calling party has blocked their caller ID information for an outgoing call they have placed, then the called party (even though they subscribe to the caller ID service) is not provided with the calling party's telephone number or other identifying information. Rather, the called party is provided with an indication that the calling party's information or telephone number is blocked or withheld or restricted or private or anonymous or unknown or otherwise unavailable.

Telemarketers and the like have been known to use the caller ID blocking feature when making telemarketing calls, e.g., to mask or hide their true identity from called parties that may otherwise avoid taking such calls if they knew from where or whom the calls were originating. For this reason and/or others, many caller ID subscribers simply do not want the intrusion of calls when the calling party's caller ID information is not available. Accordingly, there has been developed what is known as an anonymous call rejection (ACR) feature or service. Typically, when the ACR service or feature is subscribed to by a party, calls directed to that party are rejected or blocked (e.g., so that the called party's telephone or end user terminal does not ring or is not otherwise alerted) if the calling party's caller ID information (e.g., name and/or telephone number) is unavailable or otherwise cannot be provided to the called party.

Generally, with caller ID, a called party may effectively screen calls from a calling party they wish to avoid, and if the calling party attempts to withhold or block the caller ID information so as to not giving away their identity to the called party, then the called party may simply refuse to answer any such calls or employ ACR to bar the calls. Nevertheless, in some instances, a calling party may at times find it advantageous to counter such evasive tactics employed by the called party. For example, a law enforcement official or bill collector may find it advantageous to trick, fool or otherwise induce a called party to accept and/or answer a call the called party would otherwise avoid if they knew who was really calling.

Accordingly, a new and improved method and/or system for caller ID spoofing is disclosed that overcomes the above-referenced problems and others.

### SUMMARY

In accordance with one embodiment, a method of caller ID spoofing is provided. The method includes: receiving a call at a first telecommunications facility from a calling party served by the first telecommunications facility, the call being intended for a called party; determining if a caller ID spoofing feature has been invoked for the call; if the caller ID spoofing feature has not been invoked for the call, then establishing true caller ID information for the calling party; and, if the caller ID spoofing feature has been invoked for the call, then establishing false caller ID information for the calling party.

In accordance with another embodiment, a system for providing caller ID spoofing includes: means for receiving a call at a first telecommunications facility from a calling party served by the first telecommunications facility, said call being intended for a called party; and, means for determining if a caller ID spoofing feature has been invoked for the call. If the caller ID spoofing feature has not been invoked for the call, then true caller ID information is established for the calling party, otherwise if the caller ID spoofing feature has been invoked for the call, then false caller ID information is established for the calling party.

In accordance with yet another embodiment, a node supporting caller ID spoofing is provided in a telecommunications network. The node includes: means for receiving a call originated by a calling party using a terminal served by the node; means for determining if a caller ID spoofing service has been activated for the call; and, means for establishing caller ID information for the calling party, the caller ID information being true if the caller ID spoofing service has not been activated, otherwise the caller ID information being false if the caller ID spoofing service has been activated.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a block diagram illustrating an exemplary telecommunications network suitable for practicing aspects of the present inventive subject matter.

FIG. 2 is a flow chart showing an exemplary process embodying aspects of the present inventive subject matter.

### DETAILED DESCRIPTION OF PREFERRED EMBODIMENTS

For clarity and simplicity, the present specification shall refer to structural and/or functional elements, entities and/or facilities, relevant communication standards, protocols and/or services, and other components that are commonly known in the telecommunications art without further detailed explanation as to their configuration or operation except to the extent they have been modified or altered in accordance with and/or to accommodate the preferred embodiment(s) presented herein.

As described above, on occasion, a called party may opt to use caller ID and/or ACR to avoid calls from a calling party that the called party wishes to evade. Nevertheless, the calling party may wish to counter such evasion tactics. Accordingly, the present inventive subject matter described herein has been developed, whereby the calling party may opt to have the called party provided with false or misleading caller ID information to obscure or hide the true identity of the calling party or the true telephone number of the calling party. This is referred to as caller ID spoofing. Unlike caller ID blocking which withholds caller ID information from being provided to the called party altogether, caller ID spoofing still provides caller ID information to the called party, however, the caller ID information provided is false or erroneous (i.e., the provided caller ID information is not the legitimate caller ID information associated with actual calling party). As can be appreciated, caller ID spoofing has an advantage over caller ID blocking insomuch as caller ID blocking potentially tips-off the called party or leads them to believe that the call is from someone attempting to hide their identity and hence someone the called party may wish to evade. On the other hand, with caller ID spoofing, being that the called party still receives some caller ID information (albeit false or incorrect), the called party's suspicions are less likely to be aroused. In fact, as can be appreciated from continued reading of the present specification, the called party may even be tricked, fooled or otherwise induced into actually wanting to take the call, e.g., by providing false caller ID information which indicates the call is from a calling party that the called party trusts or otherwise that the call is one the called party desires to answer. For example, the false caller ID information may optionally be made to indicate that the call is from a relative or friend of the called party, an accomplice of the called party, a sweepstake provider, etc.

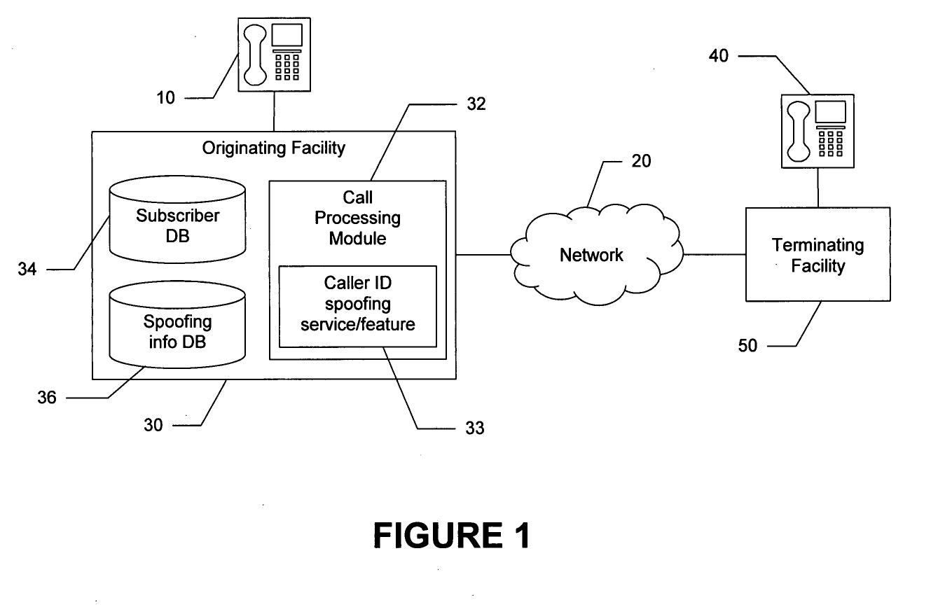

With reference to FIG. 1, a calling party or subscriber uses an end user terminal or end instrument or originating station or terminal 10 to selectively place or originate telephone calls over a telecommunications network 20, e.g., a public switched telephone network (PSTN). Suitably, the terminal 10 receives service and/or obtains access to the network 20 via an originating exchange, switching facility, end office (EO) or other network node or telecommunications facility 30 that is operatively connected to and/or in communication with the network 20 in the usual manner. Similarly, a called party uses an end user terminal or end instrument or terminating station or terminal 40 to selectively receive telephone calls over the telecommunications network 20. Suitably, the terminal 40 receives service and/or obtains access to the network 20 via a terminating exchange, switching facility, end office (EO) or other network node or telecommunications facility 50 that is also operatively connected to and/or in communication with the network 20 in the usual manner. While for simplicity and clarity herein only one originating terminal 10 and one terminating terminal 40 and one originating facility 30 and one terminating facility 50 are illustrated in the present example, it is to be appreciated that any one facility suitably serves a plurality of similarly situated terminals and that a plurality of such facilities are similarly equipped and/or likewise arranged with respect to the network 20. Moreover, it is to be appreciated that in some instances a common facility serves as both the originating facility and the terminating facility, i.e., the originating terminal 10 and the terminating terminal 40 both receive service and/or obtain access to the network 20 via the same facility.

Suitably, on the originating side, the terminal 10 and facility 30 are implemented in either a landline or wireline configuration or a wireless or mobile configuration, and likewise, on the terminating side, the terminal 40 and facility 50 are implemented in either a landline or wireline configuration or a wireless or mobile configuration. For example, in a landline or wireline configuration, the terminal 10 or 40 is optionally a landline telephone or other like end user telecommunication device or landline customer premises equipment (CPE), and the facility 30 or 50 serving the respective terminal is an EO, exchange or other network node that is operatively connected to the network 20 (e.g., the PSTN) in the usual manner. Suitably, the EO, exchange or other network node includes a telecommunications switch (e.g., a class 5 switch such as the 5ESS or another SS7 switch or other like switch) to which the respective terminal 10 or 40 is operatively connected in the usual manner, e.g., via a twisted-pair landline cable, wire or the like. In a wireless or mobile configuration, e.g., the facility 30 or 50 serving the respective terminal 10 or 40 is optionally a mobile switching center (MSC) or other like network node operatively connected to and/or in communication with the network 20 in the usual manner. Suitably, the MSC is also operatively connected to and/or in communication with a plurality of base stations (not shown) in the usual manner. As is understood in the art, each base station (BS) provides an over-the-air radio frequency interface for its respective geographic area or cell. Selectively, the terminal 10 or 40 (which in this embodiment is a mobile or wireless telephone or other appropriate mobile station (MS)) is provided telecommunication services and/or otherwise accesses the network 20 via the interface and/or the BS serving the cell in which the MS is located.

In a suitable embodiment, the terminal 40 is a caller ID enabled terminal. That is to say, in the usual manner, the terminal 40 is provisioned, equipped or otherwise associated with a caller ID reader or the like which is capable of and/or suitable for receiving or otherwise obtaining caller ID information and interpreting and/or translating the same. As is typical with caller ID enabled devices, the terminal 40 or the caller ID reader or other like device is also provisioned, equipped or otherwise has access to a display or other output device that is capable of and/or suitable for displaying or otherwise outputting the received or otherwise obtained caller ID information so as to be perceivable by the called party. Suitably, the terminating facility 50 is equipped or otherwise provisioned in the usual manner to receive or otherwise obtain caller ID information (e.g., from the facility 30) and provide, send or otherwise communicate the same to the terminal 40 or the caller ID reader or other like device provisioned, equipped or otherwise associated with the terminal 40. Accordingly, when the terminating facility 50 provides, sends or otherwise communicates caller ID information to the terminal 40 (or the caller ID reader or other like device provisioned, equipped or otherwise associated therewith), the provided caller ID information is displayed or otherwise output via the respective display or other output device so as to be perceivable by the called party.

For example, when the calling party places or originates a call to the called party using the terminal 10, optionally, the originating facility 30 sends or otherwise communicates certain caller ID information (e.g., a telephone number or line number or directory number) to the facility 50 during the call setup. Suitably, the caller ID information is contained in a CPNM if SS7 protocols are being used, but optionally it is contained in other suitable messages or signals depending on the network signaling protocol being employed. Generally, under normal operating conditions (i.e., without the calling party employing caller ID spoofing), the caller ID information sent or otherwise communicated by the originating facility 30 to the terminating facility 50 is in fact accurate, i.e., the true telephone number or line number or directory number of the actual calling party. However, if the calling party does employ the caller ID spoofing feature or service described herein, then the caller ID information sent or otherwise communicated by the originating facility 30 to the terminating facility 50 is optionally arbitrary, inaccurate or deliberately erroneous, i.e., not the true telephone number or line number or directory number of the calling party. In either case, having received the CPNM or other like message or signal from the originating facility 30, the terminating facility 50 extracts or otherwise obtains the caller ID information therefrom and communicates the same to the called party's terminal 40, e.g., in SDMF or MDMF or another appropriate format. Optionally, the caller ID information obtained from the originating facility 30 by the terminating facility 50 is translated by the facility 50 and/or communicated to the terminal 40 using FSK, e.g., the caller ID information communicated to the terminal 40 is contained in a message or signal provided by the facility 50 to the terminal 40 between the first and second ring or other alerting signals. Alternately, the caller ID information is communicated from the terminating facility 50 to the terminal 40 in any other suitable manner. In turn, the terminal 40 or associated caller ID reader or other like device decodes the signal or otherwise obtains the caller ID information received from the terminating facility 50 and displays or otherwise outputs the same via the display or other output device so as to be perceivable by the called party. Accordingly, the caller ID information ultimately perceived by the called party corresponds to the caller ID information supplied by the facility 30 (whether that caller ID information is true or false).

Suitably, the facility 30 is provisioned with or otherwise supports a caller ID spoofing feature or service. In the illustrated example, the facility 30 is provisioned or equipped with or otherwise has access to a call processing module (CPM) 32 or the like. Optionally, the CPM 32 is responsible for and/or regulates the call setup and/or the call processing for the facility 30 in the usual manner. Suitably, the CPM 32 is also responsible for administering and/or controlling the caller ID spoofing service/feature, which is indicated functionally by the box labeled with reference numeral 33.

As shown, the facility 30 also includes or otherwise has available thereto a subscriber database (DB) 34 that is selectively queried or accessed by the facility 30 to check on the status of an end user's or calling party's subscription. For example, the DB 34 suitably contains information identifying which end users or calling parties served by the facility 30 subscribe to the caller ID spoofing service/feature. Suitably, if the calling party does subscribe to the caller ID spoofing service/feature, then they are able to invoke or otherwise use the caller ID spoofing service/feature supported by the facility 30, otherwise if the calling party does not subscribe to the caller ID spoofing service/feature, then they are denied access to or use thereof. That is to say, suitably, the facility 30 is provisioned to allow subscribers to access the caller ID spoofing service/feature, while denying access to non-subscribers. Optionally, the facility 30 captures or otherwise obtains the calling party's identity (e.g., via their telephone number, line number, mobile identification number or other suitable identification) which is provided when the calling party attempts to initiate or originate a call using the terminal 10 served by the facility 30. This captured or otherwise obtained ID is then check by the facility 30 against the subscriber DB 34 to determine if the calling party is a subscriber to the caller ID spoofing service/feature provided or otherwise supported by the facility 30.

For exemplary purposes herein, it shall be assumed that the calling party is using the terminal 10 to place or originate a call to the called party using the terminal 40 to receive the call, and that the calling party is a subscriber to the caller ID spoofing service/feature, unless otherwise noted or indicated. During normal operation (i.e., without the calling party invoking or otherwise using the caller ID spoofing service/feature), the facility 30 handles the call setup and forwards the caller ID information to the terminating facility 50 in the usual manner. That is to say, the facility 30 captures or otherwise obtains the calling party's true telephone number, line number, mobile identification number or other suitable identification data, establishes accurate or true caller ID information based thereon and forwards the same to the terminating facility 50, all in any suitable manner known in the art. However, when the calling party invokes or otherwise uses the caller ID spoofing service/feature, the true or accurate caller ID information which the facility 30 would normally establish and/or forward to the terminating facility 50 is replaced, overwritten or otherwise supplanted with spoofed caller ID information, i.e., arbitrary, false, inaccurate or otherwise deliberately erroneous caller ID information. Accordingly, the terminating facility 50 receives the spoofed caller ID information rather than the true caller ID information, and in turn supplies the spoofed caller ID information to the terminal 40 and the same is displayed or otherwise output so as to be perceivable by the called party. In this way, the called party is tricked, fooled or otherwise mislead into thinking or believing that the call is from someone other than the actual calling party.

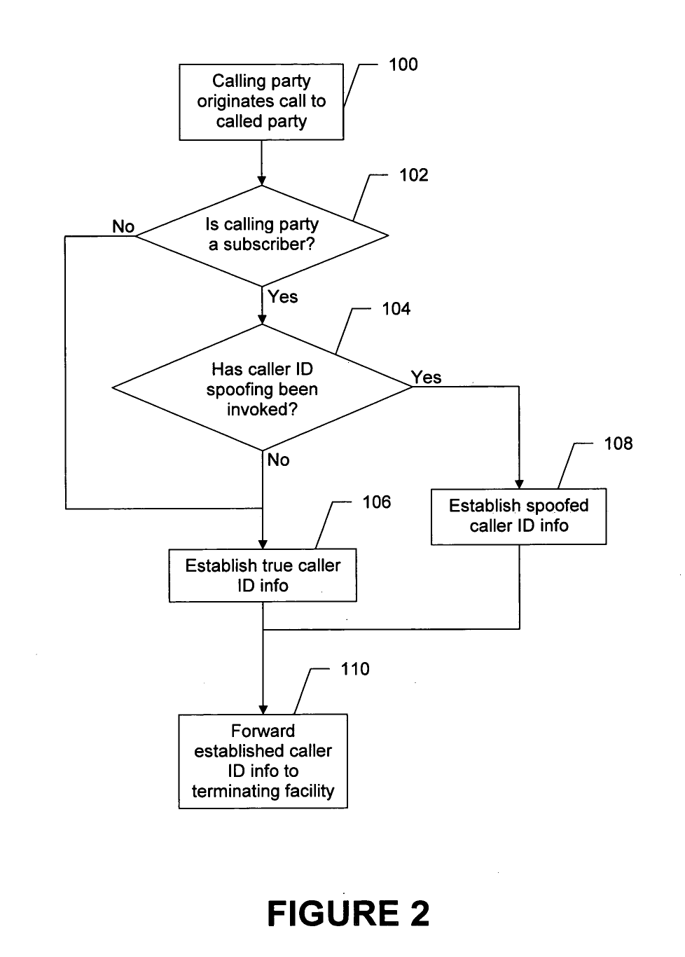

With reference to FIG. 2, a flow chart provides an example of how the caller ID spoofing service/feature is administered by the facility 30 for a call originated from the terminal 10 and directed to the telephone number of or otherwise intended for the terminal 40. As illustrated, the process begins at step 100 with the calling party employing the terminal 10 served by the facility 30 to place or originate a call over the network 20 to the terminal 40 of the called party which is served by the facility 50. Except as otherwise noted or indicated herein, the calling party optionally uses the originating terminal 10 in the usual manner to initiate or place the call. At decision step 102, it is determined if the calling party subscribes to the caller ID spoofing service/feature, e.g., as described above. If the calling party is not a subscriber to the caller ID spoofing service/feature, then the process branches to step 106, otherwise if the calling party is a subscriber to the caller ID spoofing service/feature, then the process continues on to step 104.

At decision step 104, the facility 30 determines if the caller ID spoofing feature has been invoked or is otherwise being used by the calling party. Suitably, to invoke or otherwise use the caller ID spoofing service/feature the calling party employs the originating terminal 10 to signal the facility 30 of the calling party's desire or intent to invoke or active the caller ID spoofing service/feature. For example, the calling party selectively employs the terminal 10 to dial or otherwise enter a prescribed feature code or other feature triggering key, key sequence or other entry or input so that the terminal 10 sends or otherwise communicates a signal or message to the facility 30 which is recognized by the facility 30 as invoking or activating the caller ID spoofing service/feature. For example, optionally, the prescribed feature code or the like is entered prior to the calling party dialing the telephone number to which the call is being placed. As illustrated, if the caller ID spoofing service/feature has not been invoked or activated, then the process continues on to step 106, otherwise if the caller ID spoofing service/feature has been invoked or activated, then the process branches to step 108.

At step 106, the facility 30 establishes caller ID information for the call placed at step 100 in the normal manner, i.e., using the true or actual caller ID information. Alternately, at step 108, the facility establishes caller ID information for the call placed at step 100 using spoofed caller ID information. Finally, at step 110, the facility 30 forwards or otherwise communicates the established caller ID information (whether true or spoofed as the case maybe) to the terminating facility 50 serving the terminal 40 of the called party to which the call was placed.

Optionally, the spoofed caller ID information is established by the facility 30 in one or more of a variety of different ways. In one suitable embodiment, the facility 30 includes or otherwise has access to a spoofing caller ID information DB 36 (as shown in FIG. 1). For example, the DB 36 contains spoofed caller ID information, such as one or more false or fake telephone or directory numbers. Accordingly, when the caller ID spoofing service/feature is invoked or activated for a given call, the DB 36 is accessed and a false or fake number is selected therefrom by the facility 30 to establish the spoofed caller ID information. Optionally, the false or fake information or data is randomly or otherwise arbitrarily selected from the DB 36 by the facility 30, or alternately, a particular false or fake entry is selected from the DB 36 at the direction of or based upon input from the calling party. For example, the calling party optionally employs the terminal 10 to signal or otherwise send a message to the facility 30 indicating which false or fake entry from the DB 36 the calling party desires or intents to use for the particular call being placed. In another suitable embodiment, the spoofed caller ID information is directly entered or otherwise input or selected by the calling party. For example, using the terminal 10, the calling party optionally enters a false or fake number that the facility 30 receives and uses to establish the spoofed caller ID information. Optionally, the false or fake number is dialed or otherwise entered via the terminal 10 following entry of the feature code or other suitable input that invokes or otherwise activates the caller ID spoofing service/feature. That is to say, for example, using the terminal 10, the calling party first dials or enters the prescribed feature code, then the false or fake number to be used in establishing the spoofed caller ID information, and then the telephone number of the called party.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method of caller ID spoofing, said method comprising:
(a) receiving a call at a first telecommunications facility from a calling party served by the first telecommunications facility, said call being intended for a called party;
(b) determining if a caller ID spoofing feature has been invoked for the call;
(c) if the caller ID spoofing feature has not been invoked for the call, then establishing true caller ID information for the calling party; and,
(d) if the caller ID spoofing feature has been invoked for the call, then establishing false caller ID information for the calling party.

2. The method of claim 1, said method further comprising:
(e) forwarding the established caller ID information to a second telecommunications facility which serves the called party such that the established caller ID information received by the second telecommunications facility is provided to the called party.

3. The method of claim 1, wherein step (d) comprises:
selecting the false caller ID information from a database accessible by the first telecommunications facility.

4. The method of claim 3, wherein the false caller ID information is randomly or arbitrarily selected from the database.

5. The method of claim 3, wherein the false caller ID information is selected from the database based upon input received by the first telecommunications facility from the calling party.

6. The method of claim 1, wherein step (d) comprises:
receiving the false caller ID information at the first telecommunications facility from the calling party.

7. A system for providing caller ID spoofing, said system comprising:
means for receiving a call at a first telecommunications facility from a calling party served by the first telecommunications facility, said call being intended for a called party; and,
means for determining if a caller ID spoofing feature has been invoked for the call;
wherein, if the caller ID spoofing feature has not been invoked for the call, then establishing true caller ID information for the calling party, otherwise if the caller ID spoofing feature has been invoked for the call, then establishing false caller ID information for the calling party.

8. The system of claim 7, said system further comprising:
means for forwarding the established caller ID information to a second telecommunications facility which serves the called party such that the established caller ID information received by the second telecommunications facility is provided to the called party.

9. The system of claim 7, said system further comprising:
means for selecting the false caller ID information from a database accessible by the first telecommunications facility.

10. The system of claim 9, wherein the false caller ID information is randomly or arbitrarily selected from the database.

11. The system of claim 9, wherein the false caller ID information is selected from the database based upon input received by the first telecommunications facility from the calling party.

12. The system of claim 7, said system further comprising:
means for receiving the false caller ID information at the first telecommunications facility from the calling party.

13. In a telecommunications network, a node supporting caller ID spoofing, said node comprising:
means for receiving a call originated by a calling party using a terminal served by the node;
means for determining if a caller ID spoofing service has been activated for the call; and,
means for establishing caller ID information for the calling party, said caller ID information being true if the caller ID spoofing service has not been activated, otherwise said caller ID information being false if the caller ID spoofing service has been activated.

14. The node of claim 13, said node further comprising:
means for communicating the established caller ID information to another node in the telecommunications network, said other node serving another terminal to which the call is directed.

15. The node of claim 13, wherein said node is one of a telecommunications network exchange, an end office, a mobile switching center or a telecommunication switching facility.
